(19) United States
(12) Patent Application Publication
(10) Pub. No.: US 2009/0260132 A1
(43) Pub. Date: Oct. 22, 2009

(54) Clothing with complementary designs and method of use

(76) Inventors: Jodi Tomlinson, Ponce Inlet, FL (US); Kevin P. Cutlip, Ponce Inlet, FL (US)

Correspondence Address: Paul S. Rooy;Registered Patent Attorney, 2620 South Peninsula Drive, Daytona Beach, FL, 32118, US

(21) Appl. No.: 12/148,022

(22) Filed: Apr. 16, 2008

(51) Int. Cl. A41D 27/08; A41D 27/00; G09F 21/02

(52) U.S. Cl. 2/244; 2/243.1; 40/586

(57) ABSTRACT

Clothing with complementary designs. A plurality of upper body garmnents is disclosed, each with at least one design segment. The design segments are designed to mutually complement, so that when the design segments are placed adjacent each other they form a unified design. In this fashion a visual team or group identity is created, and the aesthetic appearance of the individuals wearing the upper body garments bearing design segments is enhanced. The instant invention may be used with individuals riding motorcycles in tandem, jet skiers, sledders, rowing teams, etc. A method of use is also disclosed wherein individuals wearing the upper body garments with design segments are positioned so that the design segments form a unified design.

### BACKGROUND OF THE INVENTION

1. Field of the Invention

This invention relates to upper garments, and in particular to Clothing With Complementary Designs and Method of Use.

2. Background of the Invention

There are many possible reasons for coordinating the appearance of clothing worn by two or more persons so as to create a common visual identity. These may include sports team identification, academic class membership, membership in social or religious organizations, club identity, family membership, identification with a significant other, group membership, etc.

### Existing Designs

One approach is for each group member to each wear a T-shirt, jacket, sports jersey, or other upper body clothing item which is identical to that worn by the other group member(s). While this solution achieves group identity for the group members, the overall effect is somewhat monotonous, because all group members are wearing identical garments.

Another approach may be the use of name tags to identify group members. While this approach permits different garments to be worn by the group members, the aesthetic possibilities are limited to the small canvas afforded the name tag artist, and the small size of the name tags renders reading same difficult from a distance.

Thus, it would be desirable to provide clothing with complementary designs, which are not monotonous, and simultaneously not limited to the small surface area of a name tag.

### SUMMARY OF THE INVENTION

Accordingly, it is an object of the present invention to provide clothing with complementary designs which create a novel aesthetic appearance together. Design features allowing this object to be accomplished include a first upper body garment having a first upper body garment design segment on one of its sides, and a second upper body garment having a second upper body garment design segment on a corresponding second upper body garment side, the first upper body garment design segment being created to coordinate with the second upper body garment design segment so as to produce a single unified design. An advantage associated with the accomplishment of this object includes increased aesthetics in the individuals participating in the display of the unified design.

It is another object of the present invention to provide clothing with complementary designs which create a group identity for the participants wearing the upper body garments. Design features allowing this object to be accomplished include a first upper body garment having a first upper body garment design segment on one of its sides, and a second upper body garment having a second upper body garment design segment on a corresponding second upper body garment side, the first upper body garment design segment being created to coordinate with the second upper body garment design segment so as to produce a single unified design. A benefit associated with the accomplishment of this object is the imbuing of a group identity to the participants which is easily observable by spectators.

It is still another object of this invention to provide clothing with complementary designs wherein an unlimited number of upper body garments may be used to display a unified design. Design features enabling the accomplishment of this object include a plurality of upper body garments, each incorporating a display segment, which when displayed adjacent each other create a single unified display. Advantages associated with the realization of this object include the creation of a group identity and enhanced aesthetics in the participants.

It is another object of this invention to provide a method of use for clothing with complementary designs which cooperate to form a unified design. Method steps permitting the accomplishment of these objectives include: A. Providing a plurality of upper body garments with respective design segment designed to form a unified design when disposed adjacent each other; B. Positioning the upper body garments in mutual proximity such that the design segments are disposed adjacent each other; C. Forming a unified design with the design segments; and D. Displaying the unified design. Advantages associated with the realization of this object include the creation of a group identity and enhanced aesthetics in the participants.

It is yet another object of this invention to provide clothing with complementary designs which are inexpensive. Design features allowing this object to be achieved include the use of components made of readily available materials and conventional production procedures and methods. Benefits associated with reaching this objective include reduced cost, and hence increased availability.

### BRIEF DESCRIPTION OF THE DRAWINGS

The invention, together with the other objects, features, aspects and advantages thereof will be more clearly understood from the following in conjunction with the accompanying drawings.

Four sheets of drawings are provided. Sheet one contains FIGS. 1 and 2. Sheet two contains FIGS. 3 and 4. Sheet three contains FIGS. 5, 6 and 7.

FIG. 1 is a side isometric view of prior art upper body garments.

FIG. 2 is a side isometric view of clothing with complementary designs creating a robot head unified design.

FIG. 3 is a side isometric view of clothing with complementary designs creating a shield unified design.

FIG. 4 is a side isometric view of two upper body garments, each incorporating a design segment, which displayed adjacent each other as depicted in FIG. 3 create a single unified design.

FIG. 5 is a side isometric view of clothing with complementary designs creating a skull-and-crossbones unified design.

FIG. 6 is a side isometric view of three upper body garments, each incorporating a design segment, creating a shield-on-ribbon unified design.

FIG. 7 is a side plan view of a shield-on-ribbon unified design.

### DETAILED DESCRIPTION OF THE PREFERRED EMBODIMENT

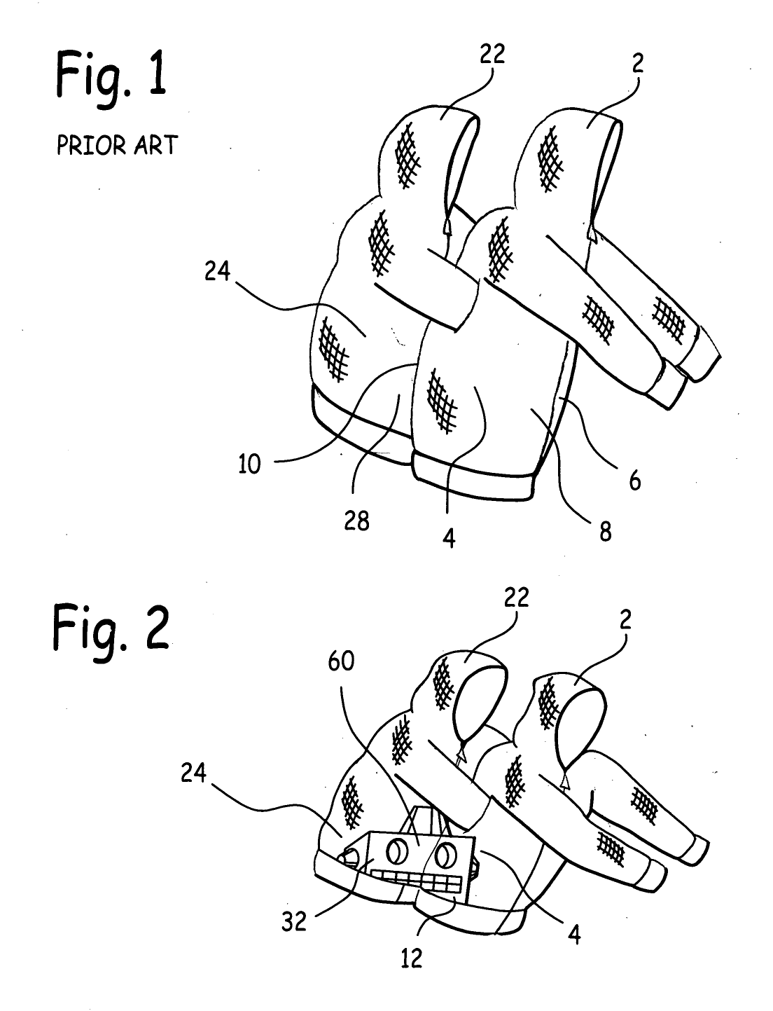

FIG. 1 is a side isometric view of prior art upper body garments. An individual wearing a first upper body garment 2 is disposed in front of an individual wearing a second upper body garment 22. This positioning of individuals is common in many arenas, including motorcycle riding, jet ski riding, sledding, rowing, etc. A salient characteristic of the positioning of multiple individuals (which may involve more than two individuals) is that respective sides of the individuals are positioned adjacent each other, thus creating a common canvas upon which a single unified design 60 (see also FIGS. 6 and 7) may be shown.

Referring now to FIGS. 1 and 2, first upper body garment 2 comprises first upper body garment first side 4, first upper body garment second side 6, first upper body garment front 8, first upper body garment back 10, and first upper body garment design segment 12 on first upper body garment first side 4.

Second upper body garment 22 comprises second upper body garment first side 24, second upper body garment second side 26, second upper body garment front 28, second upper body garment back 30, and second upper body garment design segment 32 on second upper body garment first side 24.

First upper body garment design segment 12 and second upper body garment design segment 32 are coordinated so as to create a single unified design 60 when first upper body garment first side 4 is placed adjacent second upper body garment first side 24 as depicted in FIG. 2. FIG. 2 depicts a robot head unified design 60.

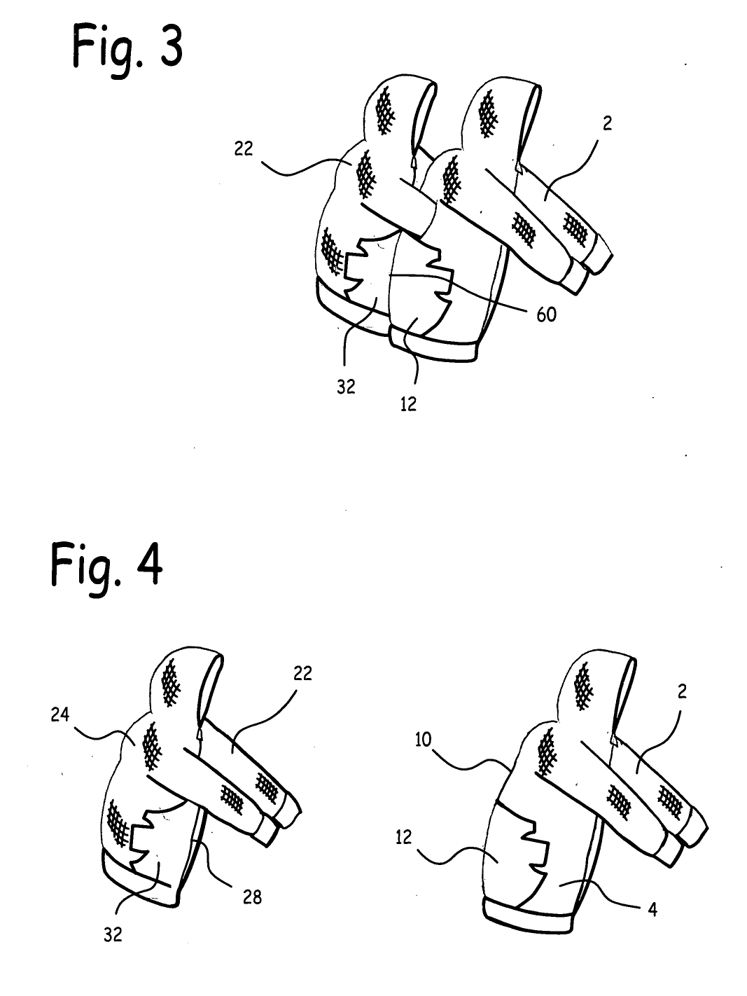

FIG. 3 is a side isometric view of first upper body garment 2 adjacent second upper body garment 22 so as to create a shield unified design 60 comprising first upper body garment design segment 12 and second upper body garment design segment 32.

FIG. 4 is a side isometric view of two upper body garments, each incorporating a design segment, which displayed adjacent each other as depicted in FIG. 3, create a single unified design 60. In the particular case depicted in FIG. 4, first upper body garment design segment 12 is disposed on first upper body garment first side 4 of first upper body garment 2, and second upper body garment design segment 32 is disposed on second upper body garment first side 24 of second upper body garment 22.

When first upper body garment 2 is placed in front of second upper body garment 22 as depicted in FIG. 3 (by placing second upper body garment front 28 against first upper body garment back 10) so as to place first upper body garment first side 4 adjacent second upper body garment first side 24, then first upper body garment design segment 12 combines with second upper body garment design segment 32 in order to create the shield unified design 60 depicted in FIG. 3.

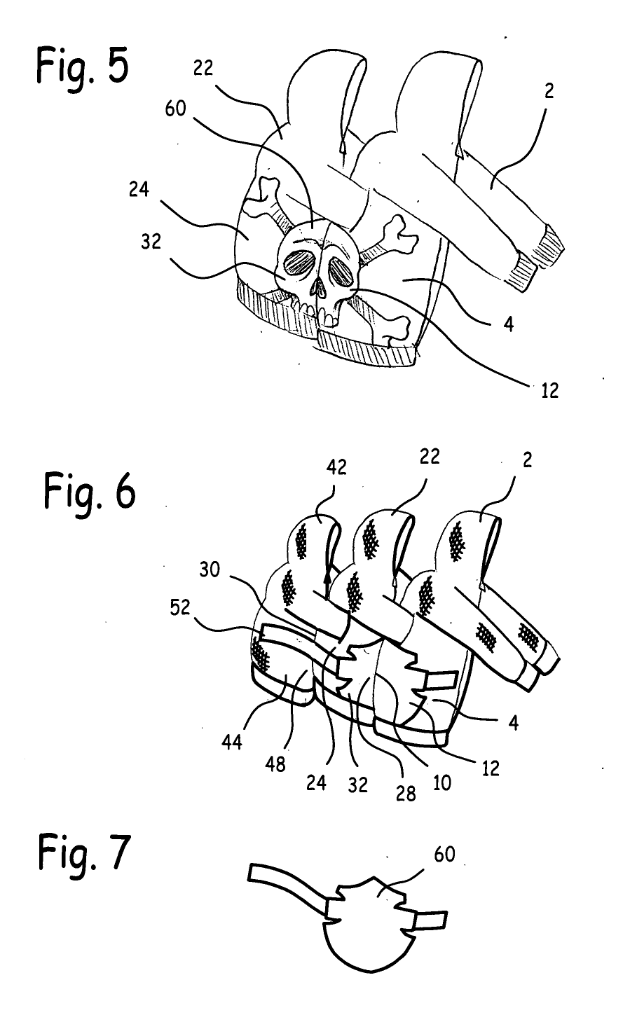

FIG. 5 is a side isometric view of clothing with complementary designs creating a skull-and-crossbones unified design 60. Skull-and-crossbones unified design 60 is comprised of first upper body garment design segment 12 on first upper body garment first side 4, and second upper body garment design segment 32 on second upper body garment first side 24.

While first upper body garment design segment 12 and second upper body garment design segment 32 have been illustrated in the figures as being disposed on first upper body garment first side 4 and second upper body garment first side 24, it is intended to fall within the scope of this disclosure that first upper body garment design segment 12 be disposed on first upper body garment second side 6 and second upper body garment design segment 32 be disposed on second upper body garment second side 26 in order to create unified design 60.

In the alternative, first upper body garment segment design 12 and second upper body garment design segment 32 may be disposed anywhere on their respective upper body garments 2, 22 appropriate to create unified design(s) 60. There may be more than one unified design 60 on the same group of two or more upper body garments. The specific location of the upper body garment design segments on their respective upper body garments may be varied depending on the optimum perspective from which it is desired that unified design 60 be viewed, relative to the group of individuals wearing the upper body garments.

FIG. 6 is a side isometric view of three upper garments, each incorporating a design segment, creating a shield-on-ribbon unified design 60. FIG. 7 depicts the shield-on-ribbon unified design 60 depicted on upper body garments 2, 22, 42 in FIG. 6. Although FIG. 6 depicts three upper body garment design segments 12, 32, 52 on respective upper body garment first sides 4, 24, 44 of upper body garments 2, 22, 42, it is intended to fall within the scope of this disclosure that an unlimited number of upper body garment design segments on respective upper body garments may be employed.

In FIG. 6, first upper body garment 2 comprises first upper body garment first side 4, first upper body garment back 10, and first upper body garment design segment 12 on first upper body garment first side 4. Second upper body garment 22 comprises second upper body garment first side 24, second upper body garment front 28, second upper body garment back 30, and second upper body garment design segment 32 on second upper body garment first side 24. Third upper body garment 42 comprises third upper body garment first side 44, third upper body garment front 48, and third upper body garment design segment 52 on third upper body garment first side 44.

When second upper body garment front 28 is placed against first upper body garment back 10 so as to place second upper body garment first side 24 adjacent first upper body garment first side 4, and third upper body garment front 48 is placed against second upper body garment back 30 so as to place third upper body garment first side 44 adjacent second upper body garment first side 24, then first upper body garment design segment 12 is positioned adjacent second upper body garment design segment 32, which in turn is positioned adjacent third upper body garment design segment 52, thus displaying the shield-on-ribbon unified design 60 depicted in FIGS. 6 and 7.

While the figures depict design segments which when assembled into a unified design are designed to be viewed from the side, it is intended to fall within the scope of this disclosure that the design segments and resulting unified design may be viewable from any desired angle of view, e.g. front quarter, rear quarter, elevated, etc.

While FIG. 6 depicts three upper body garments incorporating design segments being used to create a unified design, it is intended to fall within the scope of this disclosure that any number of upper body garments with design segments may be used, e.g. 2, 3, 4, 5, 6 and more.

Thus, the instant method comprises the steps of:

A. Providing a first upper body garment comprising a first upper body garment design segment;
B. Providing a second upper body garment comprising a second upper body garment design segment;
C. Positioning the first upper body garment in proximity to said second upper body garment such that the first upper body garment design segment is disposed adjacent the second upper body garment design segment;
D. Forming a unified design with the first upper body garment design segment and the second upper body garment design segment; and
E. Displaying the unified design.

The instant method may include the further step of providing upper body garments which comprise respective first sides, positioning said design segments on respective said first sides, and positioning said upper body garments such that said first sides are displayed adjacent each other, and said design segments combine to form a unified design on said first sides.

The instant method may include the further step of positioning individuals wearing the upper body garments en train, with a first upper body garment back against a second upper body garment front, a second upper body garment back against a third upper body garment front, etc., so that adjacent sides of the upper body garments form a canvas upon which to display the unified design.

The instant method may comprise the further step of using more than two upper body garments, each comprising at least one design segment, to form a unified design.

In the preferred embodiment, upper body garments were shirts, jackets, T-shirts, sweat shirts, vests, jerseys, uniform tops, or any other appropriate upper body garment, and were made of cloth, nylon, leather, canvas, mesh, or any other appropriate material. Each design segment was disposed on a respective upper body garment, and in the preferred embodiment design segments were silk screening, embroidery, patch, painting, airbrush art, or any other appropriate design segment.

While a preferred embodiment of the invention has been illustrated herein, it is to be understood that changes and variations may be made by those skilled in the art without departing from the spirit of the appending claims.

### DRAWING ITEM INDEX

2 first upper body garment
4 first upper body garment first side
6 first upper body garment second side
8 first upper body garment front
10 first upper body garment back
12 first upper body garment design segment
14 first upper body garment
22 second upper body garment
24 second upper body garment first side
26 second upper body garment second side
28 second upper body garment front
30 second upper body garment back
32 second upper body garment design segment
42 third upper body garment
44 third upper body garment first side
48 third upper body garment front
52 third upper body garment design segment
60 unified design

I claim:

1. Clothing with complementary designs comprising:
A first upper body garment comprising a first upper body garment design segment; and
A second upper body garment comprising a second upper body garment design segment; said first upper body garment design segment and said second upper body garment design segment forming a unified design when said first upper body garment design segment is disposed adjacent said second upper body garment design segment.

2. The clothing with complementary designs of claim 1 wherein said first upper body garment comprises a first upper body garment back, a first upper body garment side, and said second upper body garment comprises a second upper body garment front and a second upper body garment side, said first upper body garment design segment is disposed on said first upper body garment side, said second upper body garment design segment is disposed on said second upper body garment side, and said first upper body garment design segment and said second upper body garment design segment forming said unified design when said second upper body garment front is placed against said first upper body garment back, thereby positioning said first upper body garment side adjacent said second upper body garment side.

3. The clothing with complementary designs of claim 1 further comprising at least one additional upper body garment, each said additional upper body garment comprising a respective additional upper body garment design segment, said design segments being mutually complementary so as to form a single unified design when placed adjacent each other.

4. The clothing with complementary designs of claim 1 wherein each of the design segments are designed so that the resulting unified design is best observable from a pre-defined perspective.

5. A method of use for clothing with complementary designs comprising the steps of:
A. Providing a first upper body garment comprising a first upper body garment design segment;
B. Providing a second upper body garment comprising a second upper body garment design segment;
C. Positioning said first upper body garment in proximity to said second upper body garment such that said first upper body garment design segment is disposed adjacent said second upper body garment design segment;
D. Forming a unified design with said first upper body garment design segment and said second upper body garment design segment; and
E. Displaying said unified design.

6. The method of use for clothing with complementary designs of claim 5 comprising the further step of providing a side on each of the upper body garments, positioning said design segments on respective said sides, and positioning said upper body garments such that said upper body garment sides are displayed adjacent each other, and said design segments combine to form a unified design on said upper body garment sides.

7. The method of use for clothing with complementary designs of claim 6 comprising the further step of providing at least one additional upper body garment, a design segment on each said additional upper body garment, said design segments being designed to mutually complement so as to form a unified design when positioned adjacent each other, and positioning said upper body garment design segments adjacent each other to form a unified design.

8. The method of use for clothing with complementary designs of claim 7 including the further steps of providing an individual to wear each said upper body garment, positioning the individuals wearing said upper body garments en train, with a first upper body garment back against a second upper body garment front, a second upper body garment back against a third upper body garment front, and so on, so that adjacent sides of the upper body garments form a canvas upon which to display said unified design.

9. Clothing with complementary designs comprising a plurality of upper body garments, each said upper body garment comprising a respective design segment, said design segments being designed to mutually complement each other so as to form a single unified design when disposed adjacent each other.

10. The clothing with complementary designs of claim 9 further comprising an individual wearing each said upper body garment, the individuals being disposed en train front-to-back, so that said design segments are disposed adjacent each other and form a unified design.

11. The clothing with complementary designs of claim 10 wherein each of the design segments are designed so that the resulting unified design is best observable from a pre-defined perspective.

12. A method of use for clothing with complementary designs comprising the steps of:
A. Providing a plurality of upper body garments, each said upper body garment comprising a respective design segment, said design segments being designed to mutually complement each other so as to form a single unified design when disposed adjacent each other;
B. Positioning the upper body garments in mutual proximity such that the design segments are disposed adjacent each other;
C. Forming a unified design with said design segments; and
D. Displaying said unified design.

13. The method of use for clothing with complementary designs of claim 12 comprising the further steps of providing an individual to wear each said upper body garment, each said individual donning one said upper body garment, and positioning the individuals wearing said upper body garments so that said design segments are positioned adjacent each other and mutually complement each other so as to form said unified design.

14. The method of use for clothing with complementary designs of claim 13 comprising the further step of designing said design segments so that said resulting unified design is best observable from a pre-defined perspective.
